(19) United States
(12) Patent Application Publication
(10) Pub. No.: US 2025/0234306 A1
(43) Pub. Date: Jul. 17, 2025

(54) UE FEEDBACK FOR CROSS-LINK INTERFERENCE MITIGATION

(71) Applicant: Nokia Technologies Oy, Espoo (FI)

(72) Inventors: Youngsoo YUK, Seoul (KR); Roberto MALDONADO, Aalborg (DK)

(21) Appl. No.: 18/853,821

(22) PCT Filed: Jul. 5, 2022
(86) PCT No.: PCT/US2022/036081

§ 371 Date: Oct. 3, 2024

(51) Int. Cl. H04W 52/36; H04B 17/318; H04W 52/14

(52) U.S. Cl. CPC H04W 52/365; H04B 17/328; H04W 52/146

(57) ABSTRACT

An apparatus comprising: at least one processor; and at least one memory including computer program code; wherein the at least one memory and the computer program code are configured to, with the at least one processor, cause the apparatus at least to: determine whether to report a power headroom report value to a network node, the power headroom report value being applicable to a mixed slot where simultaneous transmissions in downlink and uplink are scheduled in non-overlapping sub-bands of the same carrier; wherein the power headroom report value is based on a difference between an uplink transmit power given an expected cross link interference for a user equipment, and an uplink transmit power at the mixed slot; and determine whether to reduce the uplink transmit power at the mixed slot, based on information received from the network node.

### TECHNICAL FIELD

The examples and non-limiting example embodiments relate generally to communications and, more particularly, to UE feedback for cross-link interference mitigation.

### BACKGROUND

It is known to attempt to reduce interference for a user equipment in a communication network.

### SUMMARY

In accordance with an aspect, an apparatus includes at least one processor; and at least one memory including computer program code; wherein the at least one memory and the computer program code are configured to, with the at least one processor, cause the apparatus at least to: determine whether to report a power headroom report value to a network node, the power headroom report value being applicable to a mixed slot where simultaneous transmissions in downlink and uplink are scheduled in non-overlapping sub-bands of the same carrier; wherein the power headroom report value is based on a difference between an uplink transmit power given an expected cross link interference for a user equipment, and an uplink transmit power at the mixed slot; and determine whether to reduce the uplink transmit power at the mixed slot, based on information received from the network node.

In accordance with an aspect, an apparatus includes at least one processor; and at least one memory including computer program code; wherein the at least one memory and the computer program code are configured to, with the at least one processor, cause the apparatus at least to: determine whether a mixed slot is expected to be used, the mixed slot being where simultaneous transmissions in downlink and uplink are scheduled in non-overlapping sub-bands of the same carrier; and transmit information to at least one user equipment, the information configured to be used with the at least one user equipment to determine whether to report a power headroom report value, the power headroom report value being applicable to the mixed slot; wherein the power headroom report value is based on a difference between an uplink transmit power given an expected cross link interference for the at least one user equipment, and an uplink transmit power at the mixed slot; wherein the information is configured to be used with the at least one user equipment to determine whether to reduce the uplink transmit power at the mixed slot.

In accordance with an aspect, an apparatus includes at least one processor; and at least one memory including computer program code; wherein the at least one memory and the computer program code are configured to, with the at least one processor, cause the apparatus at least to: determine a downlink sensitivity limit that indicates an upper bound of a cross link interference level a user equipment has while the user equipment receives an acceptable signal to interference noise ratio; determine a power of the cross link interference; determine a power headroom report value so that the power of the cross link interference is less than or equal to the downlink sensitivity limit, the power headroom report value being applicable to a mixed slot where simultaneous transmissions in downlink and uplink are scheduled in non-overlapping sub-bands of the same carrier; and determine whether to report the power headroom report value, based on information received from a network node; wherein the power headroom report value is configured to be used to determine whether to reduce an uplink transmit power at the mixed slot.

In accordance with an aspect, a method includes determining whether to report a power headroom report value to a network node, the power headroom report value being applicable to a mixed slot where simultaneous transmissions in downlink and uplink are scheduled in non-overlapping sub-bands of the same carrier; wherein the power headroom report value is based on a difference between an uplink transmit power given an expected cross link interference for a user equipment, and an uplink transmit power at the mixed slot; and determining whether to reduce the uplink transmit power at the mixed slot, based on information received from the network node.

In accordance with an aspect, a method includes determining whether a mixed slot is expected to be used, the mixed slot being where simultaneous transmissions in downlink and uplink are scheduled in non-overlapping sub-bands of the same carrier; and transmitting information to at least one user equipment, the information configured to be used with the at least one user equipment to determine whether to report a power headroom report value, the power headroom report value being applicable to the mixed slot; wherein the power headroom report value is based on a difference between an uplink transmit power given an expected cross link interference for the at least one user equipment, and an uplink transmit power at the mixed slot; wherein the information is configured to be used with the at least one user equipment to determine whether to reduce the uplink transmit power at the mixed slot.

In accordance with an aspect, a method includes determining a downlink sensitivity limit that indicates an upper bound of a cross link interference level a user equipment has while the user equipment receives an acceptable signal to interference noise ratio; determining a power of the cross link interference; determining a power headroom report value so that the power of the cross link interference is less than or equal to the downlink sensitivity limit, the power headroom report value being applicable to a mixed slot where simultaneous transmissions in downlink and uplink are scheduled in non-overlapping sub-bands of the same carrier; and determining whether to report the power headroom report value, based on information received from a network node; wherein the power headroom report value is configured to be used to determine whether to reduce an uplink transmit power at the mixed slot.

In accordance with an aspect, an apparatus includes means for determining whether to report a power headroom report value to a network node, the power headroom report value being applicable to a mixed slot where simultaneous transmissions in downlink and uplink are scheduled in non-overlapping sub-bands of the same carrier; wherein the power headroom report value is based on a difference between an uplink transmit power given an expected cross link interference for a user equipment, and an uplink transmit power at the mixed slot; and means for determining whether to reduce the uplink transmit power at the mixed slot, based on information received from the network node.

In accordance with an aspect, an apparatus includes means for determining whether a mixed slot is expected to be used, the mixed slot being where simultaneous transmissions in downlink and uplink are scheduled in non-overlapping sub-bands of the same carrier; and means for transmitting information to at least one user equipment, the information configured to be used with the at least one user equipment to determine whether to report a power headroom report value, the power headroom report value being applicable to the mixed slot; wherein the power headroom report value is based on a difference between an uplink transmit power given an expected cross link interference for the at least one user equipment, and an uplink transmit power at the mixed slot; wherein the information is configured to be used with the at least one user equipment to determine whether to reduce the uplink transmit power at the mixed slot.

In accordance with an aspect, an apparatus includes means for determining a downlink sensitivity limit that indicates an upper bound of a cross link interference level a user equipment has while the user equipment receives an acceptable signal to interference noise ratio; means for determining a power of the cross link interference; means for determining a power headroom report value so that the power of the cross link interference is less than or equal to the downlink sensitivity limit, the power headroom report value being applicable to a mixed slot where simultaneous transmissions in downlink and uplink are scheduled in non-overlapping sub-bands of the same carrier; and means for determining whether to report the power headroom report value, based on information received from a network node; wherein the power headroom report value is configured to be used to determine whether to reduce an uplink transmit power at the mixed slot.

In accordance with an aspect, a non-transitory program storage device readable by a machine, tangibly embodying a program of instructions executable with the machine for performing operations is described and provided, the operations including determining whether to report a power headroom report value to a network node, the power headroom report value being applicable to a mixed slot where simultaneous transmissions in downlink and uplink are scheduled in non-overlapping sub-bands of the same carrier; wherein the power headroom report value is based on a difference between an uplink transmit power given an expected cross link interference for a user equipment, and an uplink transmit power at the mixed slot; and determining whether to reduce the uplink transmit power at the mixed slot, based on information received from the network node.

In accordance with an aspect, a non-transitory program storage device readable by a machine, tangibly embodying a program of instructions executable with the machine for performing operations is described and provided, the operations including determining whether a mixed slot is expected to be used, the mixed slot being where simultaneous transmissions in downlink and uplink are scheduled in non-overlapping sub-bands of the same carrier; and transmitting information to at least one user equipment, the information configured to be used with the at least one user equipment to determine whether to report a power headroom report value, the power headroom report value being applicable to the mixed slot; wherein the power headroom report value is based on a difference between an uplink transmit power given an expected cross link interference for the at least one user equipment, and an uplink transmit power at the mixed slot; wherein the information is configured to be used with the at least one user equipment to determine whether to reduce the uplink transmit power at the mixed slot.

In accordance with an aspect, a non-transitory program storage device readable by a machine, tangibly embodying a program of instructions executable with the machine for performing operations is described and provided, the operations including determining a downlink sensitivity limit that indicates an upper bound of a cross link interference level a user equipment has while the user equipment receives an acceptable signal to interference noise ratio; determining a power of the cross link interference; determining a power headroom report value so that the power of the cross link interference is less than or equal to the downlink sensitivity limit, the power headroom report value being applicable to a mixed slot where simultaneous transmissions in downlink and uplink are scheduled in non-overlapping sub-bands of the same carrier; and determining whether to report the power headroom report value, based on information received from a network node; wherein the power headroom report value is configured to be used to determine whether to reduce an uplink transmit power at the mixed slot.

### BRIEF DESCRIPTION OF THE DRAWINGS

The foregoing aspects and other features are explained in the following description, taken in connection with the accompanying drawings.

FIG. 1 is a block diagram of one possible and non-limiting system in which the example embodiments may be practiced.

FIG. 2 shows an example of subband non-overlapping full duplex.

FIG. 3A shows a UE-to-UE CLI inter-cell co-channel interference scenario in dynamic TDD.

FIG. 3B shows a UE-to-UE CLI intra-cell adjacent channel interference scenario in non-overlapping flexible duplex.

FIG. 4 is an illustration of the problem of intra-cell UE-to-UE CLI in non-overlapping flexible duplex.

FIG. 5 is Table 1, which shows an example of UE-to-UE CLI impact to DL reception.

FIG. 6 is Table 2, which shows a power headroom report mapping from TS 38.133.

FIG. 7 shows the derivation of maximum power during full duplex slots by the aggressor UE.

FIG. 8 shows conditional triggering for a UE's second PHR according to a UE's DL RSRP level.

FIG. 9 depicts how the new trigger of the PHR can be mapped in the specifications, such as TR 38.321, and Section 5.4.6.

FIG. 10 shows an example of CLI-RSSI measurement for UE-to-UE CLI handling.

FIG. 11 shows an example of in-band emission with various waveform spectrum shaping.

FIG. 12 is an example apparatus configured to implement the examples described herein.

FIG. 13 shows a representation of an example of non-volatile memory media.

FIG. 14 is a method to perform the examples described herein.

FIG. 15 is a method to perform the examples described herein.

FIG. 16 is a method to perform the examples described herein.

### DETAILED DESCRIPTION OF EXAMPLE EMBODIMENTS

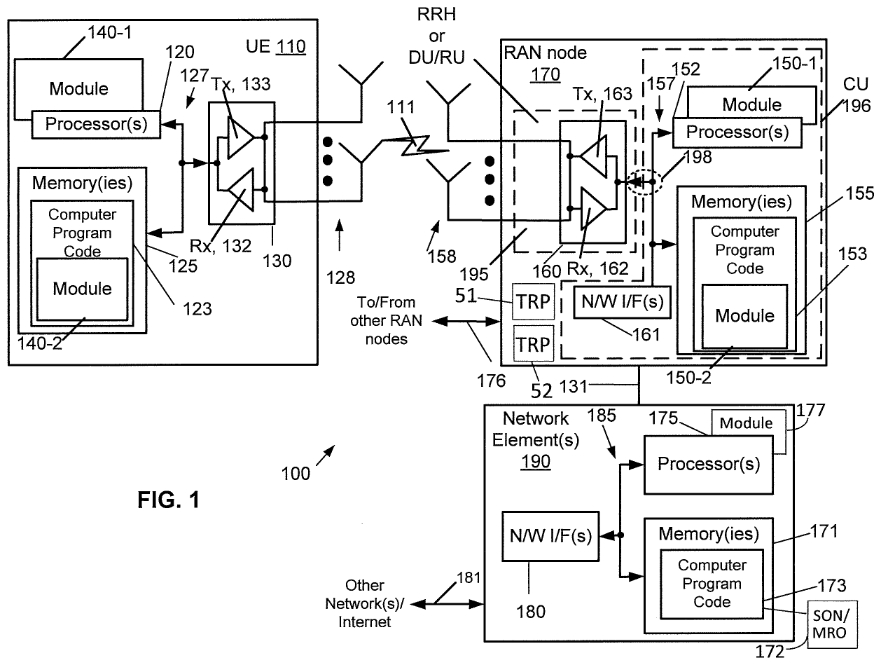

Turning to FIG. 1, this figure shows a block diagram of one possible and non-limiting example in which the examples may be practiced. A user equipment (UE) 110, radio access network (RAN) node 170, and network element(s) 190 are illustrated. In the example of FIG. 1, the user equipment (UE) 110 is in wireless communication with a wireless network 100. A UE is a wireless device that can access the wireless network 100. The UE 110 includes one or more processors 120, one or more memories 125, and one or more transceivers 130 interconnected through one or more buses 127. Each of the one or more transceivers 130 includes a receiver, Rx, 132 and a transmitter, Tx, 133. The one or more buses 127 may be address, data, or control buses, and may include any interconnection mechanism, such as a series of lines on a motherboard or integrated circuit, fiber optics or other optical communication equipment, and the like. The one or more transceivers 130 are connected to one or more antennas 128. The one or more memories 125 include computer program code 123. The UE 110 includes a module 140, comprising one of or both parts 140-1 and/or 140-2, which may be implemented in a number of ways. The module 140 may be implemented in hardware as module 140-1, such as being implemented as part of the one or more processors 120. The module 140-1 may be implemented also as an integrated circuit or through other hardware such as a programmable gate array. In another example, the module 140 may be implemented as module 140-2, which is implemented as computer program code 123 and is executed by the one or more processors 120. For instance, the one or more memories 125 and the computer program code 123 may be configured to, with the one or more processors 120, cause the user equipment 110 to perform one or more of the operations as described herein. The UE 110 communicates with RAN node 170 via a wireless link 111.

The RAN node 170 in this example is a base station that provides access for wireless devices such as the UE 110 to the wireless network 100. The RAN node 170 may be, for example, a base station for 5G, also called New Radio (NR). In 5G, the RAN node 170 may be a NG-RAN node, which is defined as either a gNB or an ng-eNB. A gNB is a node providing NR user plane and control plane protocol terminations towards the UE, and connected via the NG interface (such as connection 131) to a 5GC (such as, for example, the network element(s) 190). The ng-eNB is a node providing E-UTRA user plane and control plane protocol terminations towards the UE, and connected via the NG interface (such as connection 131) to the 5GC. The NG-RAN node may include multiple gNBs, which may also include a central unit (CU) (gNB-CU) 196 and distributed unit(s) (DUs) (gNB-DUs), of which DU 195 is shown. Note that the DU 195 may include or be coupled to and control a radio unit (RU). The gNB-CU 196 is a logical node hosting radio resource control (RRC), SDAP and PDCP protocols of the gNB or RRC and PDCP protocols of the en-gNB that control the operation of one or more gNB-DUs. The gNB-CU 196 terminates the F1 interface connected with the gNB-DU 195. The F1 interface is illustrated as reference 198, although reference 198 also illustrates a link between remote elements of the RAN node 170 and centralized elements of the RAN node 170, such as between the gNB-CU 196 and the gNB-DU 195. The gNB-DU 195 is a logical node hosting RLC, MAC and PHY layers of the gNB or en-gNB, and its operation is partly controlled by gNB-CU 196. One gNB-CU 196 supports one or multiple cells. One cell may be supported with one gNB-DU 195, or one cell may be supported/shared with multiple DUs under RAN sharing. The gNB-DU 195 terminates the F1 interface 198 connected with the gNB-CU 196. Note that the DU 195 is considered to include the transceiver 160, e.g., as part of a RU, but some examples of this may have the transceiver 160 as part of a separate RU, e.g., under control of and connected to the DU 195. The RAN node 170 may also be an eNB (evolved NodeB) base station, for LTE (long term evolution), or any other suitable base station or node.

The RAN node 170 includes one or more processors 152, one or more memories 155, one or more network interfaces (N/W I/F(s)) 161, and one or more transceivers 160 interconnected through one or more buses 157. Each of the one or more transceivers 160 includes a receiver, Rx, 162 and a transmitter, Tx, 163. The one or more transceivers 160 are connected to one or more antennas 158. The one or more memories 155 include computer program code 153. The CU 196 may include the processor(s) 152, memory(ies) 155, and network interfaces 161. Note that the DU 195 may also contain its own memory/memories and processor(s), and/or other hardware, but these are not shown.

The RAN node 170 includes a module 150, comprising one of or both parts 150-1 and/or 150-2, which may be implemented in a number of ways. The module 150 may be implemented in hardware as module 150-1, such as being implemented as part of the one or more processors 152. The module 150-1 may be implemented also as an integrated circuit or through other hardware such as a programmable gate array. In another example, the module 150 may be implemented as module 150-2, which is implemented as computer program code 153 and is executed by the one or more processors 152. For instance, the one or more memories 155 and the computer program code 153 are configured to, with the one or more processors 152, cause the RAN node 170 to perform one or more of the operations as described herein. Note that the functionality of the module 150 may be distributed, such as being distributed between the DU 195 and the CU 196, or be implemented solely in the DU 195.

The one or more network interfaces 161 communicate over a network such as via the links 176 and 131. Two or more gNBs 170 may communicate using, e.g., link 176. The link 176 may be wired or wireless or both and may implement, for example, an Xn interface for 5G, an X2 interface for LTE, or other suitable interface for other standards.

The one or more buses 157 may be address, data, or control buses, and may include any interconnection mechanism, such as a series of lines on a motherboard or integrated circuit, fiber optics or other optical communication equipment, wireless channels, and the like. For example, the one or more transceivers 160 may be implemented as a remote radio head (RRH) 195 for LTE or a distributed unit (DU) 195 for gNB implementation for 5G, with the other elements of the RAN node 170 possibly being physically in a different location from the RRH/DU 195, and the one or more buses 157 could be implemented in part as, for example, fiber optic cable or other suitable network connection to connect the other elements (e.g., a central unit (CU), gNB-CU 196) of the RAN node 170 to the RRH/DU 195. Reference 198 also indicates those suitable network link(s).

A RAN node/gNB can comprise one or more TRPs to which the methods described herein may be applied. FIG. 1 shows that the RAN node 170 comprises two TRPs, TRP 51 and TRP 52. The RAN node 170 may host or comprise other TRPs not shown in FIG. 1. The TRPs 51 and 52 may form part of the components of transceiver 160.

A relay node in NR is called an integrated access and backhaul node. A mobile termination part of the IAB node facilitates the backhaul (parent link) connection. The mobile termination part is the functionality which carries UE functionalities. The distributed unit part of the IAB node facilitates the so called access link (child link) connections (i.e. for access link UEs, and backhaul for other IAB nodes, in the case of multi-hop IAB). The distributed unit part is responsible for certain base station functionalities. The IAB scenario may follow a split architecture, where the central unit hosts the higher layer protocols to the UE and terminates the control plane and user plane interfaces to the 5G core network.

It is noted that the description herein indicates that “cells” perform functions, but it should be clear that equipment which forms the cell may perform the functions. The cell makes up part of a base station. That is, there can be multiple cells per base station. For example, there could be three cells for a single carrier frequency and associated bandwidth, each cell covering one-third of a 360 degree area so that the single base station's coverage area covers an approximate oval or circle. Furthermore, each cell can correspond to a single carrier and a base station may use multiple carriers. So if there are three 120 degree cells per carrier and two carriers, then the base station has a total of 6 cells.

The wireless network 100 may include a network element or elements 190 that may include core network functionality, and which provides connectivity via a link or links 181 with a further network, such as a telephone network and/or a data communications network (e.g., the Internet). Such core network functionality for 5G may include location management functions (LMF(s)) and/or access and mobility management function(s) (AMF(S)) and/or user plane functions (UPF(s)) and/or session management function(s) (SMF(s)). Such core network functionality for LTE may include MME (Mobility Management Entity)/SGW (Serving Gateway) functionality. Such core network functionality may include SON (self-organizing/optimizing network) functionality. These are merely example functions that may be supported by the network element(s) 190, and both 5G and LTE functions may be supported. The RAN node 170 is coupled via a link 131 to the network element 190. The link 131 may be implemented as, e.g., an NG interface for 5G, or an SI interface for LTE, or other suitable interface for other standards. The network element 190 includes one or more processors 175, one or more memories 171, and one or more network interfaces (N/W I/F(s)) 180, interconnected through one or more buses 185. The one or more memories 171 include computer program code 173. Computer program code 173 may include SON and/or MRO functionality 172.

The one or more network elements 190 comprises a module 177 that may include Near-Real-Time RIC functionality. Computer program code 173 may include Near-Real-Time RIC functionality. Module 150-1 and/or module 150-2 may include Near-Real-Time RIC functionality.

The wireless network 100 may implement network virtualization, which is the process of combining hardware and software network resources and network functionality into a single, software-based administrative entity, a virtual network. Network virtualization involves platform virtualization, often combined with resource virtualization. Network virtualization is categorized as either external, combining many networks, or parts of networks, into a virtual unit, or internal, providing network-like functionality to software containers on a single system. Note that the virtualized entities that result from the network virtualization are still implemented, at some level, using hardware such as processors 152 or 175 and memories 155 and 171, and also such virtualized entities create technical effects.

The computer readable memories 125, 155, and 171 may be of any type suitable to the local technical environment and may be implemented using any suitable data storage technology, such as semiconductor based memory devices, flash memory, magnetic memory devices and systems, optical memory devices and systems, non-transitory memory, transitory memory, fixed memory and removable memory. The computer readable memories 125, 155, and 171 may be means for performing storage functions. The processors 120, 152, and 175 may be of any type suitable to the local technical environment, and may include one or more of general purpose computers, special purpose computers, microprocessors, digital signal processors (DSPs) and processors based on a multi-core processor architecture, as non-limiting examples. The processors 120, 152, and 175 may be means for performing functions, such as controlling the UE 110, RAN node 170, network element(s) 190, and other functions as described herein.

In general, the various example embodiments of the user equipment 110 can include, but are not limited to, cellular telephones such as smart phones, tablets, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, tablets with wireless communication capabilities, head mounted displays such as those that implement virtual/augmented/mixed reality, as well as portable units or terminals that incorporate combinations of such functions. The UE 110 can also be a vehicle such as a car, or a UE mounted in a vehicle, a UAV such as e.g. a drone, or a UE mounted in a UAV.

UE 110, RAN node 170, and/or network element(s) 190, (and associated memories, computer program code and modules) may be configured to implement (e.g. in part) the methods described herein, including UE feedback for cross-link interference mitigation. Thus, computer program code 123, module 140-1, module 140-2, and other elements/features shown in FIG. 1 of UE 110 may implement user equipment related aspects of the methods described herein. Computer program code 153, module 150-1, module 150-2, and other elements/features shown in FIG. 1 of RAN node 170 may implement gNB/TRP related aspects of the methods described herein. Computer program code 173 and other elements/features shown in FIG. 1 of network element(s) 190 may be configured to implement network element related aspects of the methods described herein.

Having thus introduced a suitable but non-limiting technical context for the practice of the example embodiments, the example embodiments are now described with greater specificity.

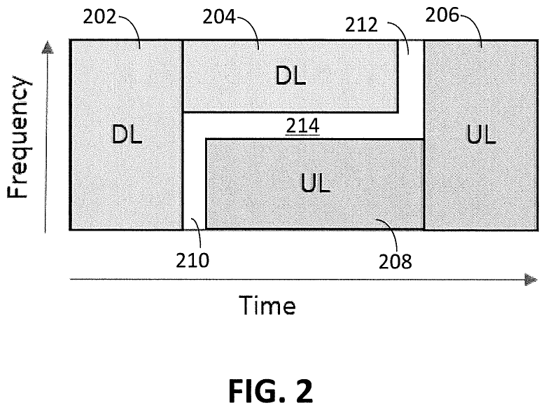

The examples described herein are related to CLI management for subband non-overlapping full duplex operation. FIG. 2 shows an example of resource allocation of subband non-overlapping full duplex operation.

Within a same carrier, downlink and uplink resource blocks (including DL resources 202 and 204 and uplink resources 206 and 208) are simultaneously scheduled in a non-overlapping manner with FDM and TDM. To minimize the power leakage from DL to UL and vice versa there is a guard in time/frequency between DL and UL resource blocks. Refer to guards in time (210, 212), and the guard in frequency (214). This type of operation generates new challenges as new interference components are created.

First, there is cross-link interference (CLI) between UL and DL blocks in the same OFDM symbol at a given node. In a gNB receiver (e.g. Rx 162 of RAN node 170), the UL reception is hindered by the simultaneous DL transmission since power from the transmitter chain leakages to the receiver chain and creates the so called self-interference. This can be removed by a gNB advanced cancellation schemes, because the interference generated (DL signal) is known to the gNB. Since it is typically assumed that UEs have half-duplex capabilities, the self-interference component is not present at the UE side.

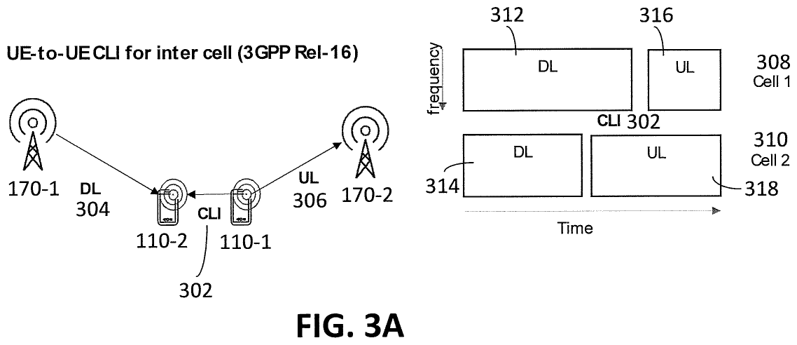

FIG. 3A shows an aggressor UE 110-1 transmitting in uplink (306) while the victim UE 110-2 is receiving in downlink (304). FIG. 3A shows another CLI component, in this case the interference created between UEs also known as UE-to-UE CLI (302). This type of interference has been previously studied in 3GPP for dynamic TDD operation. As the outcome of the study, in Release 16, means to measure the UE-to-UE CLI (302) between UEs (110-1 and 110-2) in different cells (inter-cell UE-to-UE CLI), such as Cell 1 308 and Cell 2 310, has been specified (see FIG. 3A). Specifically, the introduced measurements are based on the SRS resources of the UE 110-1 transmitting in UL, e.g. UL 306 to network node 170-2. It is worth noticing that in Release 16, the UE-to-UE CLI 302 is inter-cell co-channel interference. As shown in FIG. 3A, network node 170-1 transmits a DL transmission 304 to UE 110-2 while network node 170-2 receives a UL transmission 306 from UE 110-1. Shown in FIG. 3A are DL resources (312, 314) and UL resources (316, 318). Network node 170-1 provides access to cell 1 308, and network node 170-2 provides access to cell 2 310.

However, in subband non-overlapping full duplex in Rel-18, the UE-to-UE CLI is intra-cell adjacent interference 320 (see FIG. 3B). Not enough spatial separation may cause an impact to the UE's DL reception (DL reception 324 of UE 110-2) as it is interfered by another UE's UL transmission (UL transmission 322 of UE 110-1). Also, for UE-to-UE interference 320, because the UL signal 322 from the aggressor UE 110-1 is unknown to the victim UE 110-2, when receiving the DL signal 324, the UE 110-2 cannot apply any interference cancellation schemes. Also, a guard band (210, 212, 214) is used for reducing interference, so the interference level decreases with several dBs without explicit filtering.

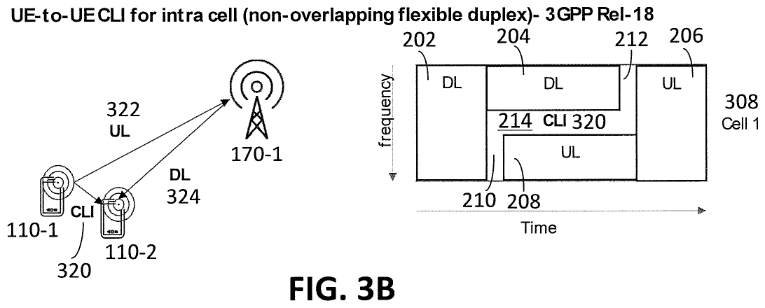

FIG. 4 illustrates the problem of intra-cell UE-to-UE CLI 320. Assume an UL UE 110-1 (aggressor) is transmitting with TX power of X dBm (401), while DL UE 110-2 (victim) is receiving with RX RSRP of Y dBm (402) near at UL UE 110-1.

The UL TX in-band ACLR (404) is the ratio of signal power of the UL resource 410 to signal power leaked to the DL resource 412, and Delta 406 is propagation loss between the UEs (110-1 and 110-2) assuming minimum 40 dB (general assumption). Then, the SINR 408 of DL signal 402 is roughly calculated as:

$$DL SINR = DL Rx RSRP ( Y ) - ( UL Tx Power ( X ) - UL in - band ACLR - Delta )$$

The above equation corresponds to item 408 being equal to item 402 minus (item 401 minus item 404 minus item 406).

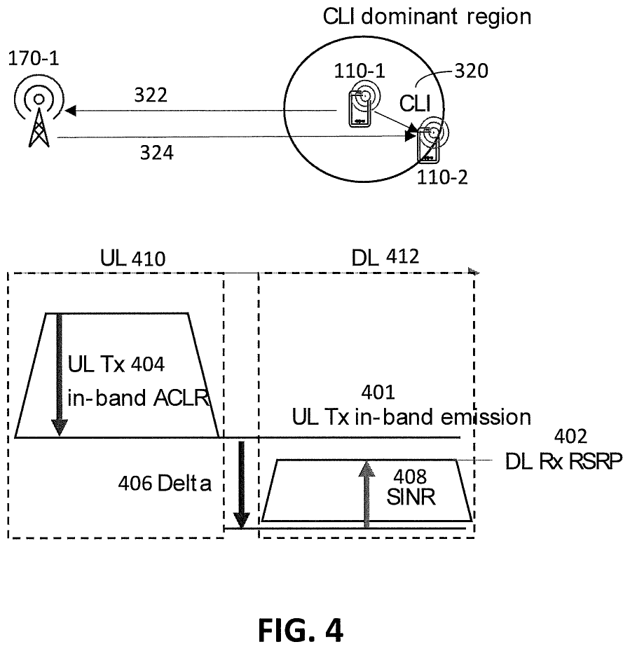

Table 1 (FIG. 5) shows the example of DL SINR calculation when assuming UL TX in-band ACLR (404) is 45 dB. As shown in Table 1 (FIG. 5), DL SINR 408 is seriously degraded by the UL UE's Tx power (401) when UE 110-2 is at the cell edge, and even in the cell center. Some of the parameters can be different according to the UE's implementation, for example, in-band ACLR can be large if any shaping filter is applied for the UL UE's TX signal 322 (e.g. ACLR=60 dB). Or, if the distance between the two UEs (110-1, 110-2) is large enough, the propagation loss should be much larger. For example, if Delta>90 dB, the maximum CLI=23-135=−108 dB, which is lower than a noise level, and there is no impact to DL SINR 408.

Described herein is a method to reduce the impact of the UE-to-UE CLI by managing the UL transmit power under certain circumstances.

### UE-to-UE Cross-Link Interference (Co-Channel) Measurements and Report

Release-16 introduces UE-to-UE CLI measurement for coordinated scheduling. Victim UE 110-2 reports the CLI measurement result for aggressor UE 110-1 in terms of SRS-RSRP or CLI-RSSI to the serving gNB 170-1 to indicate how strong CLI 302 is received from the other cell UL UE 110-1. But, there has been no discussion yet for intra-cell UE-to-UE CLI measurement and reporting, such as for CLI 320. A similar approach can be supported, but there is no other way other than avoiding co-scheduling of DL and UL for two adjacent UEs. Also, CLI measurement requires additional overhead for DL UE 110-2. Also, the CLI source is different for two scenarios. For inter-cell CLI 302, the interference source is the signals transmitted in the same resource as the desired signal, while for intra-cell case CLI 320, the interference source is in-band emission 401 of a UL signal 322 to the adjacent DL resource blocks (202, 204). Because the DL UE (victim UE 110-2) doesn't have information of the UL signal leaked to the DL resource in the intra-cell CLI case, it is difficult to measure accurate RSRP of the leaked signal from the UL sub-band (e.g. one or more of 206, 208) to the DL sub-band (e.g. one or more of 202, 204). Also, Rel-16 SRS-RSRP/CLI-RSSI is L3 filtered measurement, so it is difficult to be measured with dynamic DL/UL scheduling.

### Power Headroom Report

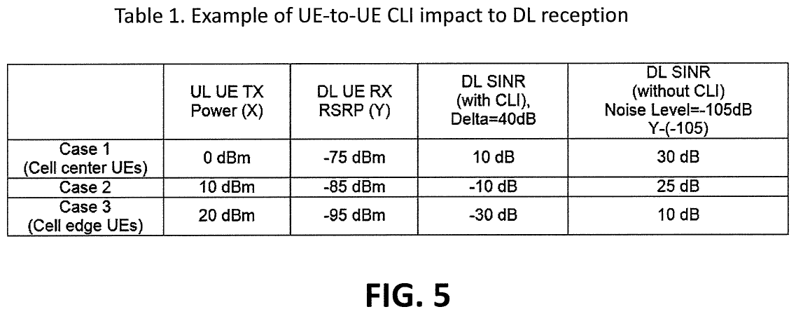

The PHR is a report by the MAC CE that informs the gNB 170 about the remaining power left at a given UE 110. This information is used at the gNB 170 to allocate more resource blocks or increase transmit power in future UL transmissions (if the PHR indicates a positive value) or less resources blocks or lower the transmit power (if the PHR indicates a negative value). The PHR is transmitted when i) a periodic timer expires or ii) the path loss to the serving cell reaches a configured threshold. FIG. 6 is Table 2, which shows a power headroom report mapping from TS 38.133.

Described herein is a method to decrease the in-band UE-to-UE CLI 320 so that a certain DL SINR level (408) is guaranteed in flexible full duplex slots (also known as mixed DL/UL slots or sub-band full duplex slots). To do so, the UE creating UE-to-UE CLI (aggressor UE 110-1) to a neighbor UE (victim UE 110-2) decreases its maximum transmit power on slots where CLI is expected. This is achieved by reporting 2 independent PHRs to the serving base station (170-1). In addition to signaling the PHR value used during UL slots (baseline operation), the second PHR value applicable to mixed slot (DL and UL are scheduled in different subbands) is also reported. In the second PHR (PHR2), the UE 110-1 applies an additional power backoff, to which extent the UL Tx power is reduced depends on the aggressor potential CLI 320 to the victim UE 110-2.

If the mixed slot is used for one half-duplex user equipment, there is no CLI. The mixed slot is at least used by two half-duplex user equipments with them being scheduled in DL and UL respectively.

The gNB 170-1 requests UEs to report PHR2 if mixed DL/UL slots are expected to be used. PHR2 can be reported as an exact value as it is done for PHR1 (refer to the previous discussion related to PHR) or it can be reported as a delta/offset from the PHR1 value. Given the knowledge of PHR2, the gNB 170-1 schedules the aggressor UE 110-1 with lower MCS, accounting for the UL Tx power reduction.

### Determining the PHR2 by the UE

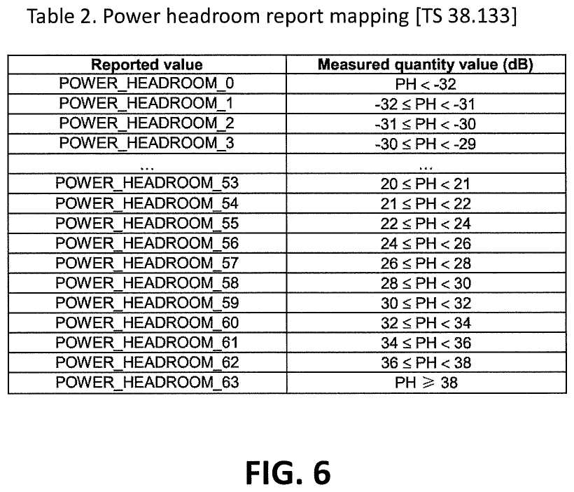

With reference to FIG. 7, the aggressor UE 110-1 assumes that the victim UE 110-2 is located near itself, and therefore the victim UE's Rx RSRP level should be similar to the aggressor UE's Rx RSRP level (item 702). Given this assumption, the aggressor UE 110-1 sets the target CLI level to be lower than certain DL sensitivity limit 704. This limit indicates the maximum UE-to-UE CLI that the victim UE 110-2 can suffer while still receiving an acceptable DL SINR. The DL sensitivity limit 704 depends on the assumed Rx RSRP 702 and it is defined as:

$${DL}_{sensitivity} = DL Rx RSRP + α$$

where α (alpha) is a positive offset configured by the serving gNB 170-1.

The aggressor UE 110-1 can determine the power of the generated CLI as:

$${CLI}_{aggressor} = UL {TX}_{power} - in band ACLR - δ$$

Where δ (delta) is the minimum propagation loss between aggressor 110-1 and victim UE 110-2 (e.g. 40 dB), and inband ACLR 708 (also in-band ACLR 708) is the power attenuation to the adjacent channel. Delta 706 can be configured via the serving gNB.

With the 2 equations above, the maximum UL Tx power that the aggressor UE 110-1 could use (P_{MAX,CLI}) 710 is calculated as:

$${P}_{MAX , CLI} = max ( UL {TX}_{power} ) where {CLI}_{aggressor} \leq {DL}_{sensitivity}$$

$${P}_{MAX , CLI} = DL RX RSRP + α + in band ACLR + δ$$

With this, the PHR2 value is obtained as:

$$PHR 2 = {P}_{MAX , CLI} - {P}_{TX}$$

As a baseline operation the UE 110-1 also calculates PHR1 as:

$$PHR 1 = {P}_{MAX} - {P}_{TX}$$

where P_{TX} is the transmit power at a given slot and P_{MAX} is the maximum allowed UE transmit power 712. The maximum power reduction of the cross link interference (MPR_CLI) is given as item 714.

### Conditional PHR2 Triggering Based on a Threshold

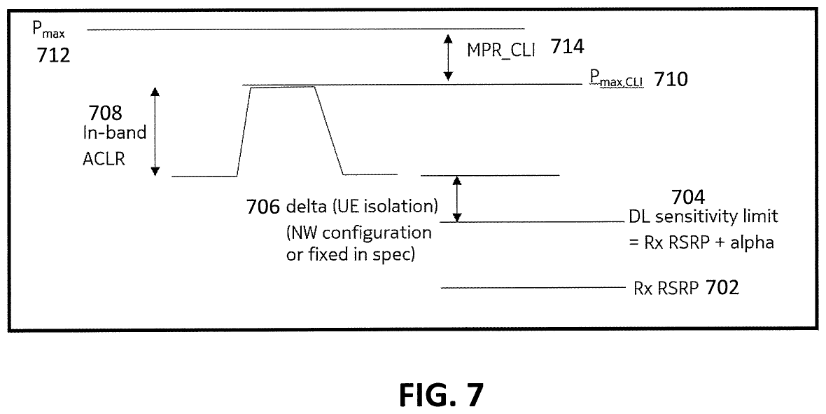

With reference to FIG. 8, there are cases in which the DL RSRP (402) of DL transmission 802 is significantly higher than the potential UE-to-UE CLI (320) resulting from UL transmission 804 and therefore there is no need to apply any CLI handling mechanisms. As shown in FIG. 8, the network configures a CLI reporting threshold (T_{RSRP,CLI}) 806 to indicate whether PHR2 is required to be calculated or not, and/or reported or not. If the observed DL RSRP (402) is lower than the configured threshold 806, e.g. −80 dBm, the UE 110-1 reports the additional PHR2.

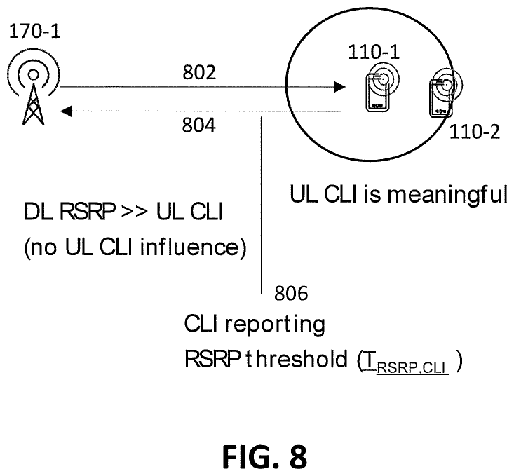

This new trigger of the PHR can be mapped in the specifications (TR 38.321, Section 5.4.6) as follows and shown in FIG. 9 (refer to item 902):

A Power Headroom Report (PHR) shall be triggered
if any of the following events occur:

phr-ProhibitTimer expires or has expired and the path loss has changed
more than phr-Tx-PowerFactorChange dB for at least one activated
Serving Cell of any MAC entity of which the active DL BWP is not
dormant BWP which is used as a pathloss reference since the last
transmission of a PHR in this MAC entity when the MAC entity has UL
resources for new transmission;
phr-PeriodicTimer expires;
upon configuration or reconfiguration of the power headroom reporting
functionality by upper layers, which is not used to disable the function;
activation of an SCell of any MAC entity with configured uplink of which
firstActiveDownlinkBWP-Id is not set to dormant BWP;
addition of the PSCell (i.e. PSCell is newly added or changed);
phr-ProhibitTimer expires or has expired, when the MAC entity has
UL resources for new transmission, and the following is true for any
of the activated Serving Cells of any MAC entity with configured uplink:
there are UL resources allocated for transmission or there is a PUCCH
transmission on this cell, and the required power backoff due to power
management (as allowed by P-MPR_{c} as specified in TS 38.101-1 [14], TS
38.101-2 [15], and TS 38.101-3 [16]) for this cell has changed more than
phr-Tx-PowerFactorChange dB since the last transmission of a PHR
when the MAC entity had UL resources allocated for transmission
or PUCCH transmission on this cell.
Upon switching of activated BWP from dormant BWP to non-dormant
DL BWP of an SCell of any MAC entity with configured uplink;
if mpe-Reporting-FR2 is configured, mpe-ProhibitTimer is not
running, and the measured P-MPR applied to meet FR2 MPE requirements
as specified in TS 38.101-2 [15] is equal to or larger than
mpe-Threshold for at least one activated FR2 Serving Cell since
the last transmission of a PHR in this MAC entity, in which
case the PHR is referred below to as ‘MPE P-MPR report’.
if full duplex deployment and the measured DL RSRP is lower than the
configured CLI reporting threshold (T_{RSRP, CLI})

### Conditional PHR2 Triggering Based on UE-to-UE Measurements

To avoid unnecessary PHR transmissions, the aggressor UE (e.g. 110 or 110-1) can measure if any proximate UE (e.g. UE 110-2) is located and sending UL. To do so, the gNB 170 can configure a CLI measurement report, similar to Rel-16 CLI-RSSI. For an aggressor UE 110 operating in a mixed DL/UL slot, CSI-IM based CLI-RSSI reporting can be configured. The UE 110-1 can be configured to solely report CLI-RSSI.

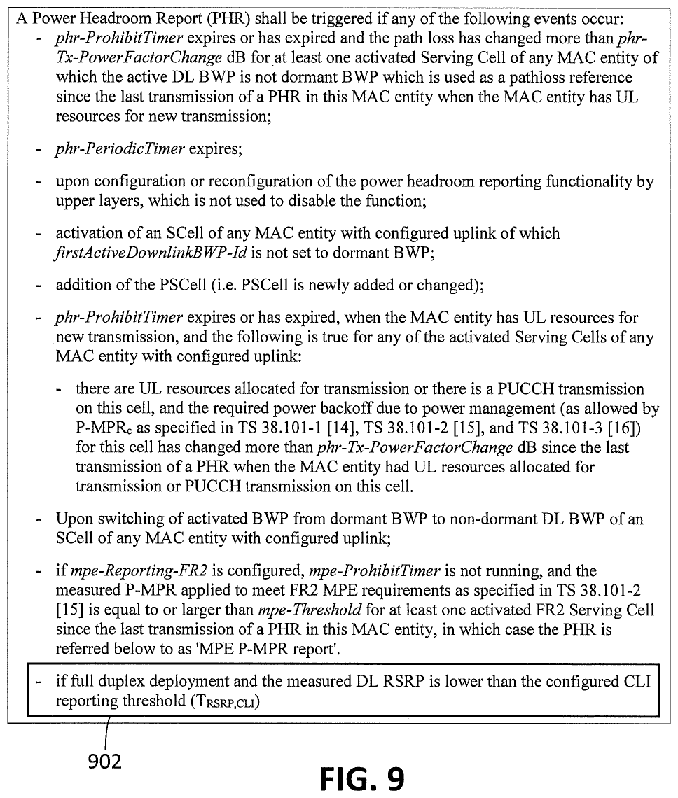

Alternatively, the aggressor UE (e.g. 110 or 110-1) can be configured with a secondary CSI reporting or aperiodic CSI reporting with one or more additional IMRs for CLI (CSI-IM for CLI) as shown in FIG. 10. CSI-IM 1011 is configured in UL subband 1012, and when UE receives DL signal with DL resource 1014, UE 110-1 also measures the RSSI of the configured CSI-IM 1011 in UL subband 1012.

Option 1 (1001): UE (110 or 110-1) Reports CLI-RSSI when CMR (1010) is Configured in UL Subband (1012).
Additionally DL RSRP can be reported, or SNR=DL RSRP-CLI-RSSI can be reported.
   Option 2 (1002): UE (110 or 110-1) Reports CSI for a Mixed Slot with the Configuration of IMR for CLI Measurement.
alpha 1016 (the positive offset used for the DL sensitivity calculation) is also provided by the network (e.g. 170, 170-1, 190) to derive the effective CLI to DL reception from the CLI-RSSI measured in CSI-IM 1011 in UL subband 1012.

### UE Capability Reporting

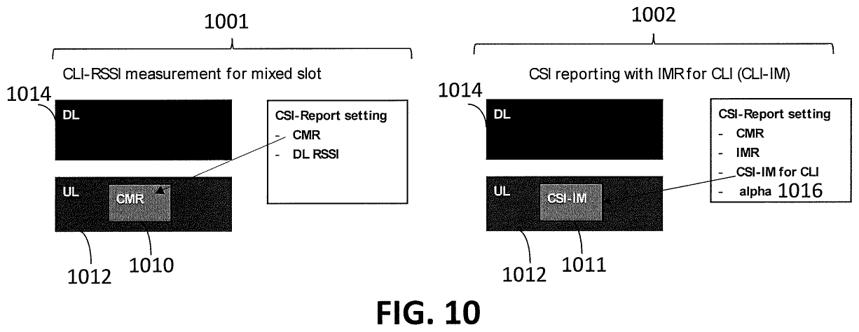

How much a UE transmission leaks to adjacent frequencies depends on its Tx capabilities. A UE 110 capable of applying advanced spectral shaping to its UL transmissions can achieve a lower ACLR. As an example, FIG. 11 shows the in-band emission level for different waveforms. As it is observed, if waveforms such as f-OFDM, UFMC or WOLA are adopted (plots 1140 1150, and 1160 respectively), the in-band emission level is much lower than with SC-FDMA and CP-OFDM (plots 1120 and 1130 respectively). Given its waveform, a UE (110, 110-1) can derive the in-channel interference to the adjacent DL subband using the allocation and the guard band sizes as inputs. The applied power reduction is UE-specific and this information can be used at the gNB 170 to configure accordingly the UE-to-UE CLI handling mechanisms. The LTE emission mask is given with plot 1110.

The UE capability can be used by the gNB (170, 170-1) to determine the threshold 806 for triggering the PHR2 (T_{RSRP,CLI}) and/or the alpha value (e.g. 1016) used during the PHR2 calculation. For instance, if a UE (110, 110-1) reports its capability to achieve very low in-band emissions levels, i.e. it generates negligible CLI, the gNB (170, 170-1) can i) disable the request for PHR2, ii) configure the UE (110, 110-1) with a higher threshold, and/or iii) decrease alpha.

The UE might report its capability in terms of an ACLR level depending on the minimum guard band size and allocation. Several values are reported for different GB sizes, e.g. ACLR1 for GB<20 PRB, ACLR2 for GB<40 PRB, etc. Similarly, the several values may be reported for different allocation BW sizes, e.g. ACLR1 (if BW<8PRB), ACLR2 (if 8<BW<16 PRB), ACLR3 (if BW>16 PRB).

Based on the reported capability, the gNB 170 might apply UE power reductions during mixed slots. The power reduction is signalled to the UE 110 as part of the UL DCI.

Advantages and technical effects of the examples described herein include efficient mitigation of UE-to-UE CLI for a mixed DL/UL slot or a plurality of mixed DL/UL slots. For the standard relevance, this is important at least due to potential standard impact, including UE report capability about in-band emission/in-band blocking, the UE's additional PHR report to be applied for mixed UL slots, the gNB's configuration of the DL sensitivity level, and the gNB's configuration of CLI measurement.

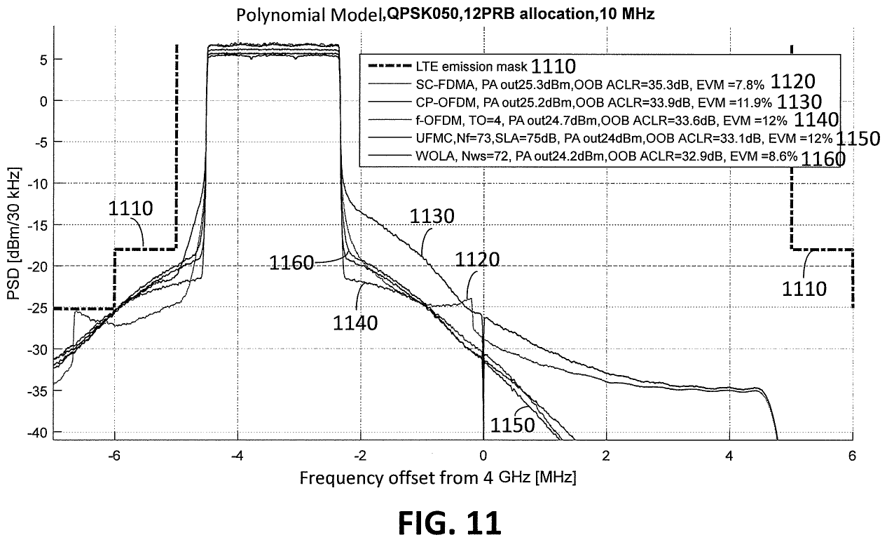

FIG. 12 is an example apparatus 1200, which may be implemented in hardware, configured to implement the examples described herein. The apparatus 1200 comprises at least one processor 1202 (e.g. an FPGA and/or CPU), at least one memory 1204 including computer program code 1205, wherein the at least one memory 1204 and the computer program code 1205 are configured to, with the at least one processor 1202, cause the apparatus 1200 to implement circuitry, a process, component, module, or function (collectively control 1206) to implement the examples described herein, including confidence-based advanced trajectory prediction. The memory 1204 may be a non-transitory memory, a transitory memory, a volatile memory (e.g. RAM), or a non-volatile memory (e.g. ROM).

The apparatus 1200 optionally includes a display and/or I/O interface 1208 that may be used to display aspects or a status of the methods described herein (e.g., as one of the methods is being performed or at a subsequent time), or to receive input from a user such as with using a keypad, camera, touchscreen, touch area, microphone, biometric recognition, one or more sensors, etc. The apparatus 1200 includes one or more communication e.g. network (N/W) interfaces (I/F(s)) 1210. The communication I/F(s) 1210 may be wired and/or wireless and communicate over the Internet/other network(s) via any communication technique. The communication I/F(s) 1210 may comprise one or more transmitters and one or more receivers. The communication I/F(s) 1210 may comprise standard well-known components such as an amplifier, filter, frequency-converter, (de) modulator, and encoder/decoder circuitries and one or more antennas.

The apparatus 1200 to implement the functionality of control 1206 may be UE 110, RAN node 170 (e.g. gNB), or network element(s) 190, as well as UE 110-1, UE 110-2, gNB 170-1, or gNB 170-2. Thus, processor 1202 may correspond to processor(s) 120, processor(s) 152 and/or processor(s) 175, memory 1204 may correspond to memory(ies) 125, memory(ies) 155 and/or memory(ies) 171, computer program code 1205 may correspond to computer program code 123, module 140-1, module 140-2, and/or computer program code 153, module 150-1, module 150-2, and/or computer program code 173 or module 177, and communication I/F(s) 1210 may correspond to transceiver 130, antenna(s) 128, transceiver 160, antenna(s) 158, N/W I/F(s) 161, and/or N/W I/F(s) 180. Alternatively, apparatus 1200 may not correspond to either of UE 110, RAN node 170, network element(s) 190, UE 110-1, UE 110-2, gNB 170-1, or gNB 170-2, as e.g. apparatus 1200 may be part of a self-organizing/optimizing network (SON) node, such as in a cloud.

The apparatus 1200 may also be distributed throughout the network (e.g. 100) including within and between apparatus 1200 and any network element (such as a network control element (NCE) 190 and/or the RAN node 170 and/or the UE 110, and/or any of UE 110-1, UE 110-2, gNB 170-1, or gNB 170-2).

Interface 1212 enables data communication between the various items of apparatus 1200, as shown in FIG. 12. For example, the interface 1212 may be one or more buses such as address, data, or control buses, and may include any interconnection mechanism, such as a series of lines on a motherboard or integrated circuit, fiber optics or other optical communication equipment, and the like. Computer program code 1205, including control 1206 may comprise object-oriented software configured to pass data/messages between objects within computer program code 1205. The apparatus 1200 need not comprise each of the features mentioned, or may comprise other features as well.

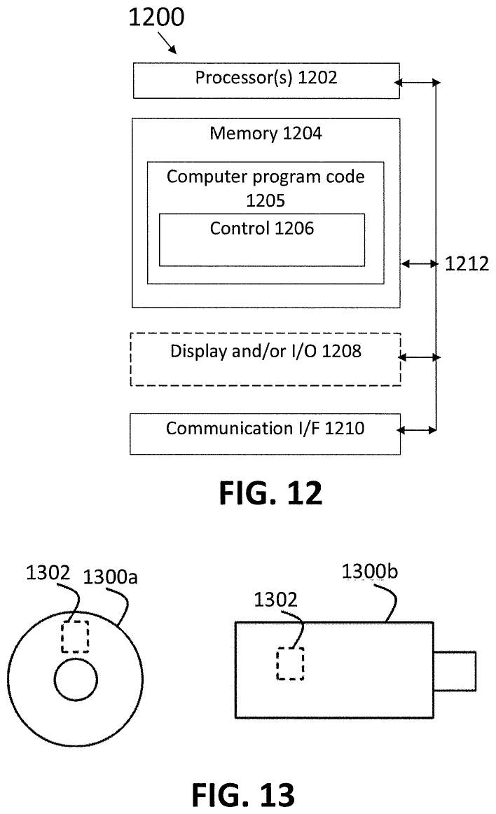

FIG. 13 shows a schematic representation of non-volatile memory media 1300a (e.g. computer disc (CD) or digital versatile disc (DVD)) and 1300b (e.g. universal serial bus (USB) memory stick) storing instructions and/or parameters 1302 which when executed by a processor allows the processor to perform one or more of the steps of the methods described previously.

It is to be noted that example embodiments may be implemented as circuitry, in software, hardware, application logic or a combination of software, hardware and application logic. In an example embodiment, the application logic, software or an instruction set is maintained on any computer-readable media. In the context of this document, a “computer-readable medium” may be any media or means that can contain, store, communicate, propagate or transport the instructions for use by or in connection with an instruction execution system, apparatus, or device, such as the base stations, network nodes, or user equipment of the above-described example embodiments.

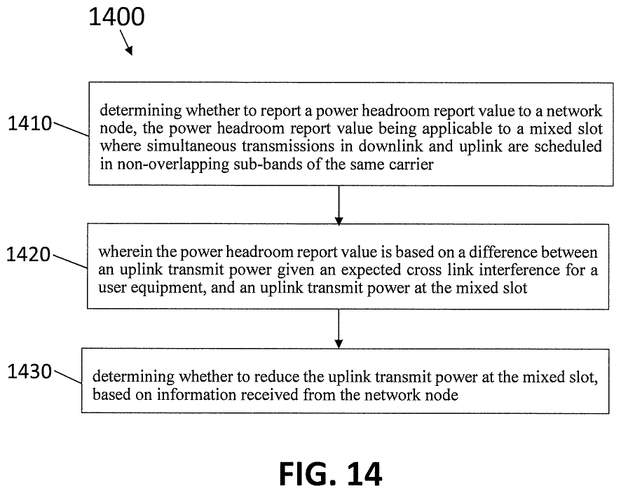

FIG. 14 is an example method 1400. At 1410, the method includes determining whether to report a power headroom report value to a network node, the power headroom report value being applicable to a mixed slot where simultaneous transmissions in downlink and uplink are scheduled in non-overlapping sub-bands of the same carrier. At 1420, the method includes wherein the power headroom report value is based on a difference between an uplink transmit power given an expected cross link interference for a user equipment, and an uplink transmit power at the mixed slot. At 1430, the method includes determining whether to reduce the uplink transmit power at the mixed slot, based on information received from the network node. Method 1400 may be performed with a user equipment (e.g. UE 110, UE 110-1, UE 110-2).

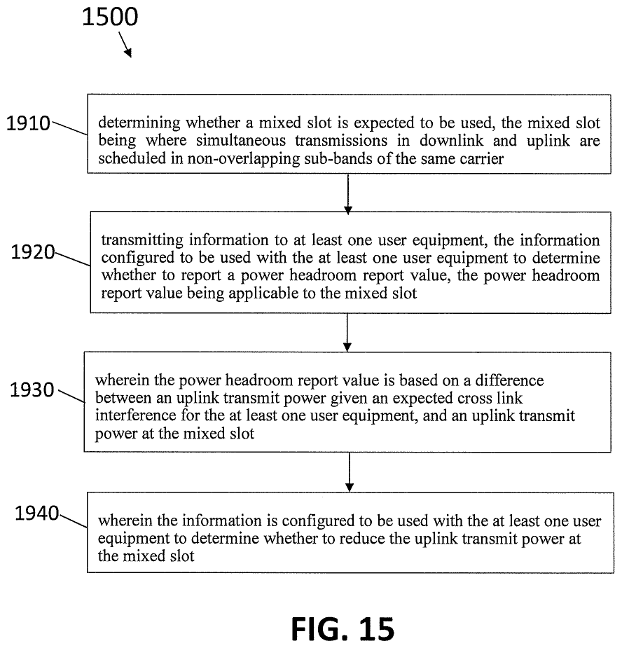

FIG. 15 is an example method 1500. At 1510, the method includes determining whether a mixed slot is expected to be used, the mixed slot being where simultaneous transmissions in downlink and uplink are scheduled in non-overlapping sub-bands of the same carrier. At 1520, the method includes transmitting information to at least one user equipment, the information configured to be used with the at least one user equipment to determine whether to report a power headroom report value, the power headroom report value being applicable to the mixed slot. At 1530, the method includes wherein the power headroom report value is based on a difference between an uplink transmit power given an expected cross link interference for the at least one user equipment, and an uplink transmit power at the mixed slot. At 1540, the method includes wherein the information is configured to be used with the at least one user equipment to determine whether to reduce the uplink transmit power at the mixed slot. Method 1500 may be performed with a network node (e.g. RAN node 170, network node 170-1, network node 170-2).

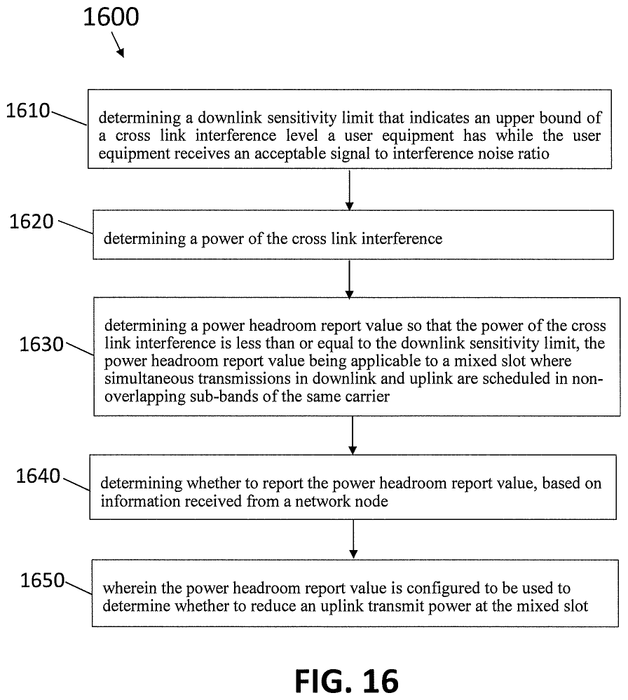

FIG. 16 is an example method 1600. At 1610, the method includes determining a downlink sensitivity limit that indicates an upper bound of a cross link interference level a user equipment has while the user equipment receives an acceptable signal to interference noise ratio. At 1620, the method includes determining a power of the cross link interference. At 1630, the method includes determining a power headroom report value so that the power of the cross link interference is less than or equal to the downlink sensitivity limit, the power headroom report value being applicable to a mixed slot where simultaneous transmissions in downlink and uplink are scheduled in non-overlapping sub-bands of the same carrier. At 1640, the method includes determining whether to report the power headroom report value, based on information received from a network node. At 1650, the method includes wherein the power headroom report value is configured to be used to determine whether to reduce an uplink transmit power at the mixed slot. Method 1600 may be performed with a user equipment (e.g. UE 110, UE 110-1, UE 110-2).

The following examples (1-60) are provided and described herein.

Example 1. An apparatus includes at least one processor; and at least one memory including computer program code; wherein the at least one memory and the computer program code are configured to, with the at least one processor, cause the apparatus at least to: determine whether to report a power headroom report value to a network node, the power headroom report value being applicable to a mixed slot where simultaneous transmissions in downlink and uplink are scheduled in non-overlapping sub-bands of the same carrier; wherein the power headroom report value is based on a difference between an uplink transmit power given an expected cross link interference for a user equipment, and an uplink transmit power at the mixed slot; and determine whether to reduce the uplink transmit power at the mixed slot, based on information received from the network node.

Example 2. The apparatus of example 1, wherein the at least one memory and the computer program code are configured to, with the at least one processor, cause the apparatus at least to: transmit, to the network node, the power headroom value applicable to the mixed slot.

Example 3. The apparatus of any of examples 1 to 2, wherein the at least one memory and the computer program code are configured to, with the at least one processor, cause the apparatus at least to: report the power headroom report value as a change from another power headroom report value, the another power headroom report value being applicable to at least one uplink slot.

Example 4. The apparatus of any of examples 1 to 3, wherein the at least one memory and the computer program code are configured to, with the at least one processor, cause the apparatus at least to: determine the power headroom report value with an assumption that a reception reference signal received power of the apparatus is substantially similar to a reception reference signal received power of the user equipment.

Example 5. The apparatus of any of examples 1 to 4, wherein the at least one memory and the computer program code are configured to, with the at least one processor, cause the apparatus at least to: determine a downlink sensitivity limit that indicates an upper bound of a cross link interference level the user equipment has while the user equipment receives an acceptable signal to interference noise ratio; determine a power of the cross link interference; and determine the power headroom report value so that the power of the cross link interference is less than or equal to the downlink sensitivity limit.

Example 6. The apparatus of example 5, wherein the at least one memory and the computer program code are configured to, with the at least one processor, cause the apparatus at least to: determine the downlink sensitivity limit as at least partially a downlink reception reference signal received power added to at least partially an offset; determine the power of the cross link interference as at least partially the uplink transmit power given the expected cross link interference minus at least partially a power attenuation to an adjacent channel minus at least partially a propagation loss between the apparatus and the user equipment.

Example 7. The apparatus of example 6, wherein the downlink reception reference signal received power is of the apparatus or the user equipment.

Example 8. The apparatus of any of examples 6 to 7, wherein the at least one memory and the computer program code are configured to, with the at least one processor, cause the apparatus at least to: receive a configuration of the offset from the network node.

Example 9. The apparatus of any of examples 1 to 8, wherein the at least one memory and the computer program code are configured to, with the at least one processor, cause the apparatus at least to: determine the uplink transmit power given the expected cross link interference as at least partially a downlink reception reference signal received power plus at least partially an offset plus at least partially a power attenuation to an adjacent channel plus at least partially a propagation loss between the apparatus and the user equipment; and determine the power headroom report value as at least partially the determined uplink transmit power given the expected cross link interference minus at least partially the uplink transmit power at the mixed slot.

Example 10. The apparatus of any of examples 1 to 9, wherein the at least one memory and the computer program code are configured to, with the at least one processor, cause the apparatus at least to: determine another power headroom report value to the network node as at least partially an allowed transmit power of the user equipment minus at least partially an uplink transmit power at an uplink slot, the another power headroom report value being applicable to the uplink slot; and report the another power headroom report value to the network node.

Example 11. The apparatus of any of examples 1 to 10, wherein the at least one memory and the computer program code are configured to, with the at least one processor, cause the apparatus at least to: determine a downlink reference signal received power of the apparatus; and report the power headroom report value to the network node, in response to the downlink reference signal received power being lower than a cross link interference reporting threshold.

Example 12. The apparatus of example 11, wherein the at least one memory and the computer program code are configured to, with the at least one processor, cause the apparatus at least to: receive a configuration comprising the cross link interference reporting threshold.

Example 13. The apparatus of any of examples 1 to 12, wherein the at least one memory and the computer program code are configured to, with the at least one processor, cause the apparatus at least to: report a cross link interference received signal strength indicator when at least one channel measurement resource is configured in an uplink sub-band.

Example 14. The apparatus of 13, wherein the at least one memory and the computer program code are configured to, with the at least one processor, cause the apparatus at least to report at least one of: a downlink reference signal receive power of the apparatus or the user equipment; or a signal to interference noise ratio, the signal to interference noise ratio computed as at least partially the downlink reference signal receive power minus at least partially the cross link interference received signal strength indicator.

Example 15. The apparatus of any of examples 1 to 14, wherein the at least one memory and the computer program code are configured to, with the at least one processor, cause the apparatus at least to: report channel state information of the mixed slot, using a configuration of a channel state information interference measurement resource.

Example 16. The apparatus of example 15, wherein the at least one memory and the computer program code are configured to, with the at least one processor, cause the apparatus at least to: receive an offset used to determine a downlink sensitivity limit that indicates an upper bound of an acceptable cross link interference level of the user equipment; determine a cross link interference received signal strength indicator measured using the channel state information interference measurement resource in an uplink sub-band; and determine the cross link interference, based on the received offset and the determined cross link interference received signal strength indicator.

Example 17. The apparatus of any of examples 1 to 16, wherein the at least one memory and the computer program code are configured to, with the at least one processor, cause the apparatus at least to: report to the network node a capability to reduce the in-band emission level.

Example 18. The apparatus of example 17, wherein the at least one memory and the computer program code are configured to, with the at least one processor, cause the apparatus at least to: receive an indication to not report the power headroom report value, based on the reported capability to reduce the in-band emission level.

Example 19. The apparatus of any of examples 17 to 18, wherein the at least one memory and the computer program code are configured to, with the at least one processor, cause the apparatus at least to: receive a threshold used to determine whether to report the power headroom report value to the network node, the threshold based on the report to the network node of the capability to reduce the in-band emission level; determine a downlink reference signal received power of the apparatus; and report the power headroom report value to the network node, in response to the downlink reference signal received power being lower than the threshold.

Example 20. The apparatus of any of examples 17 to 19, wherein the at least one memory and the computer program code are configured to, with the at least one processor, cause the apparatus at least to: receive an offset used to determine a downlink sensitivity limit that indicates an upper bound of an acceptable cross link interference level of the user equipment, the offset based on the report to the network node of the capability to reduce the in-band emission level.

Example 21. The apparatus of any of examples 17 to 20, wherein the capability to reduce an in-band emission level is reported based on an adjacent channel leakage ratio level, the adjacent channel leakage ratio level depending on transmitter characteristics, guard band size or bandwidth allocation.

Example 22. The apparatus of any of examples 1 to 21, wherein the at least one memory and the computer program code are configured to, with the at least one processor, cause the apparatus at least to: reduce the uplink transmit power at the mixed slot where the cross link interference is expected.

Example 23. An apparatus includes at least one processor; and at least one memory including computer program code; wherein the at least one memory and the computer program code are configured to, with the at least one processor, cause the apparatus at least to: determine whether a mixed slot is expected to be used, the mixed slot being where simultaneous transmissions in downlink and uplink are scheduled in non-overlapping sub-bands of the same carrier; and transmit information to at least one user equipment, the information configured to be used with the at least one user equipment to determine whether to report a power headroom report value, the power headroom report value being applicable to the mixed slot; wherein the power headroom report value is based on a difference between an uplink transmit power given an expected cross link interference for the at least one user equipment, and an uplink transmit power at the mixed slot; wherein the information is configured to be used with the at least one user equipment to determine whether to reduce the uplink transmit power at the mixed slot.

Example 24. The apparatus of example 23, wherein the at least one memory and the computer program code are configured to, with the at least one processor, cause the apparatus at least to: receive, from the at least one user equipment, the power headroom report value applicable to the mixed slot.

Example 25. The apparatus of any of examples 23 to 24, wherein the at least one memory and the computer program code are configured to, with the at least one processor, cause the apparatus at least to: receive the power headroom report value as a change from another power headroom report value.

Example 26. The apparatus of any of examples 23 to 25, wherein the at least one memory and the computer program code are configured to, with the at least one processor, cause the apparatus at least to: transmit an offset to the at least one user equipment, the offset configured to be used with the at least one user equipment to determine a downlink sensitivity limit that indicates an upper bound of a cross link interference level the user equipment has while the user equipment receives an acceptable signal to interference noise ratio, the downlink sensitivity limited determined as at least partially a downlink reception reference signal received power added to at least partially the offset; and transmit a delta value to the at least one user equipment, the delta value configured to be used with the at least one user equipment to determine a power of the cross link interference as at least partially the uplink transmit power given the expected cross link interference minus at least partially a power attenuation to an adjacent channel minus at least partially the delta value; wherein the delta value represents a propagation loss between a first user equipment of the at least one user equipment and a second user equipment of the at least one user equipment.

Example 27. The apparatus of example 26, wherein the downlink reception reference signal received power is of the at least one user equipment or another user equipment.

Example 28. The apparatus of any of examples 26 to 27, wherein the at least one memory and the computer program code are configured to, with the at least one processor, cause the apparatus at least to: transmit a configuration comprising the offset to the at least one user equipment.

Example 29. The apparatus of any of examples 23 to 28, wherein the at least one memory and the computer program code are configured to, with the at least one processor, cause the apparatus at least to: receive another power headroom report value from the at least one user equipment; wherein the another power headroom report value is determined as at least partially an allowed transmit power of the at least one user equipment minus at least partially an uplink transmit power at an uplink slot, the another power headroom report value being applicable to the uplink slot.

Example 30. The apparatus of any of examples 23 to 29, wherein the at least one memory and the computer program code are configured to, with the at least one processor, cause the apparatus at least to: transmit a cross link interference reporting threshold to the at least one user equipment; and receive the power headroom report value from the at least one user equipment, in response to a downlink reference signal received power of the at least one user equipment being lower than the cross link interference reporting threshold.

Example 31. The apparatus of example 30, wherein the at least one memory and the computer program code are configured to, with the at least one processor, cause the apparatus at least to: transmit a configuration comprising the cross link interference reporting threshold to the at least one user equipment.

Example 32. The apparatus of any of examples 23 to 31, wherein the at least one memory and the computer program code are configured to, with the at least one processor, cause the apparatus at least to: transmit a configuration of at least one channel measurement resource in an uplink sub-band; receive a report of a cross link interference received signal strength indicator based on the configuration of the at least one channel measurement resource.

Example 33. The apparatus of 32, wherein the at least one memory and the computer program code are configured to, with the at least one processor, cause the apparatus at least to receive a report of at least one of: a downlink reference signal receive power of the at least one user equipment; or a signal to interference noise ratio, the signal to interference noise ratio computed as at least partially the downlink reference signal receive power minus at least partially the cross link interference received signal strength indicator.

Example 34. The apparatus of any of examples 23 to 33, wherein the at least one memory and the computer program code are configured to, with the at least one processor, cause the apparatus at least to: transmit a configuration of a channel state information interference measurement resource; and receive a report of channel state information of the mixed slot, based on the configuration of the channel state information interference measurement resource.

Example 35. The apparatus of example 34, wherein the at least one memory and the computer program code are configured to, with the at least one processor, cause the apparatus at least to: transmit an offset configured to be used to determine a downlink sensitivity limit that indicates an upper bound of an acceptable cross link interference level of the at least one user equipment; wherein a cross link interference received signal strength indicator is measured using the channel state information interference measurement resource in an uplink sub-band; wherein the cross link interference is determined, based on the transmitted offset and the measured cross link interference received signal strength indicator.

Example 36. The apparatus of any of examples 23 to 35, wherein the at least one memory and the computer program code are configured to, with the at least one processor, cause the apparatus at least to: receive a report of a capability of the at least one user equipment to reduce the in-band emission level.

Example 37. The apparatus of example 36, wherein the at least one memory and the computer program code are configured to, with the at least one processor, cause the apparatus at least to: determine a threshold based on the report of the capability of the at least one user equipment to reduce the in-band emission level; and transmit the threshold to the at least one user equipment, the threshold configured to be used to determine whether to report the power headroom report value.

Example 38. The apparatus of any of examples 36 to 37, wherein the at least one memory and the computer program code are configured to, with the at least one processor, cause the apparatus at least to: determine an offset based on the report of the capability of the at least one user equipment to reduce the in-band emission level; and transmit the offset to the at least one user equipment, the offset configured to be used to determine a downlink sensitivity limit that indicates an upper bound of an acceptable cross link interference level of the at least one user equipment.

Example 39. The apparatus of any of examples 36 to 38, wherein the capability to reduce an in-band emission level is reported based on an adjacent channel leakage ratio level, the adjacent channel leakage ratio level depending on the transmitter characteristics, guard band size or bandwidth allocation.

Example 40. The apparatus of any of examples 23 to 39, wherein the at least one memory and the computer program code are configured to, with the at least one processor, cause the apparatus at least to: transmit downlink control information comprising an indication of a reduction of the uplink transmit power at the mixed slot where the cross link interference is expected; and schedule the at least one user equipment with a lower modulation and coding scheme, based on the reduction of the uplink transmit power at the mixed slot.

Example 41. The apparatus of any of examples 23 to 40, wherein the at least one memory and the computer program code are configured to, with the at least one processor, cause the apparatus at least to: receive a report of a capability of the at least one user equipment to reduce the in-band emission level; and determine, based on the report of the capability of the at least one user equipment to reduce an in-band emission level, whether the expected cross link interference is negligible.

Example 42. The apparatus of example 41, wherein the at least one memory and the computer program code are configured to, with the at least one processor, cause the apparatus at least to: disable a request for the power headroom report value, in response to determining that the expected cross link interference is negligible.

Example 43. The apparatus of any of examples 41 to 42, wherein the at least one memory and the computer program code are configured to, with the at least one processor, cause the apparatus at least to: configure the at least one user equipment with a higher cross link interference reporting threshold, in response to determining that the expected cross link interference is negligible; and receive the power headroom report value from the at least one user equipment, in response to a downlink reference signal received power of the at least one user equipment being lower than the cross link interference reporting threshold.

Example 44. The apparatus of any of examples 41 to 43, wherein the at least one memory and the computer program code are configured to, with the at least one processor, cause the apparatus at least to: decrease an offset, in response to determining that the expected cross link interference is negligible; wherein the offset is configured to be used to determine a downlink sensitivity limit as at least partially a downlink reception reference signal received power added to at least partially the offset; wherein the downlink sensitivity limit indicates an upper bound of a cross link interference level the at least one user equipment has while the at least one user equipment receives an acceptable signal to interference noise ratio; and receive the power headroom report value from the at least one user equipment, in response to the expected cross link interference being less than the downlink sensitivity level.

Example 45. An apparatus includes at least one processor; and at least one memory including computer program code; wherein the at least one memory and the computer program code are configured to, with the at least one processor, cause the apparatus at least to: determine a downlink sensitivity limit that indicates an upper bound of a cross link interference level a user equipment has while the user equipment receives an acceptable signal to interference noise ratio; determine a power of the cross link interference; determine a power headroom report value so that the power of the cross link interference is less than or equal to the downlink sensitivity limit, the power headroom report value being applicable to a mixed slot where simultaneous transmissions in downlink and uplink are scheduled in non-overlapping sub-bands of the same carrier; and determine whether to report the power headroom report value, based on information received from a network node; wherein the power headroom report value is configured to be used to determine whether to reduce an uplink transmit power at the mixed slot.

Example 46. The apparatus of example 45, wherein the at least one memory and the computer program code are configured to, with the at least one processor, cause the apparatus at least to: receive an offset from the network node; determine the downlink sensitivity limit as at least partially a downlink reception reference signal received power added to at least partially the offset; receive a delta value from the network node, the delta value representing a propagation loss between the apparatus and the user equipment; and determine the power of the cross link interference as at least partially the uplink transmit power given an expected cross link interference minus at least partially a power attenuation to an adjacent channel minus at least partially the delta value.

Example 47. The apparatus of example 46, wherein the downlink reception reference signal received power is of the apparatus or the user equipment.

Example 48. The apparatus of any of examples 45 to 47, wherein the at least one memory and the computer program code are configured to, with the at least one processor, cause the apparatus at least to: determine the uplink transmit power given an expected cross link interference as at least partially a downlink reception reference signal received power plus at least partially an offset plus at least partially a power attenuation to an adjacent channel plus at least partially a propagation loss between the apparatus and the user equipment; and determine the power headroom report value as at least partially the determined uplink transmit power given the expected cross link interference minus at least partially an uplink transmit power at the mixed slot.

Example 49. The apparatus of any of examples 45 to 48, wherein the at least one memory and the computer program code are configured to, with the at least one processor, cause the apparatus at least to: report to the network node a capability to reduce an in-band emission level; receive an offset used to determine the downlink sensitivity limit that indicates the upper bound of the acceptable cross link interference level of the user equipment, the offset based on the report to the network node of the capability to reduce the in-band emission level.

Example 50. The apparatus of example 49, wherein the at least one memory and the computer program code are configured to, with the at least one processor, cause the apparatus at least to: receive an indication to not report the power headroom report value, based on the reported capability to reduce the in-band emission level, the information received from the network node comprising the indication.

Example 51. The apparatus of any of examples 45 to 50, wherein the at least one memory and the computer program code are configured to, with the at least one processor, cause the apparatus at least to: receive, from the network node, a configuration comprising a cross link interference reporting threshold, the information received from the network node comprising the indication; determine a downlink reference signal received power of the apparatus; and report the power headroom report value to the network node, in response to the downlink reference signal received power being lower than the cross link interference reporting threshold.

Example 52. A method includes determining whether to report a power headroom report value to a network node, the power headroom report value being applicable to a mixed slot where simultaneous transmissions in downlink and uplink are scheduled in non-overlapping sub-bands of the same carrier; wherein the power headroom report value is based on a difference between an uplink transmit power given an expected cross link interference for a user equipment, and an uplink transmit power at the mixed slot; and determining whether to reduce the uplink transmit power at the mixed slot, based on information received from the network node.

Example 53. A method includes determining whether a mixed slot is expected to be used, the mixed slot being where simultaneous transmissions in downlink and uplink are scheduled in non-overlapping sub-bands of the same carrier; and transmitting information to at least one user equipment, the information configured to be used with the at least one user equipment to determine whether to report a power headroom report value, the power headroom report value being applicable to the mixed slot; wherein the power headroom report value is based on a difference between an uplink transmit power given an expected cross link interference for the at least one user equipment, and an uplink transmit power at the mixed slot; wherein the information is configured to be used with the at least one user equipment to determine whether to reduce the uplink transmit power at the mixed slot.

Example 54. A method includes determining a downlink sensitivity limit that indicates an upper bound of a cross link interference level a user equipment has while the user equipment receives an acceptable signal to interference noise ratio; determining a power of the cross link interference; determining a power headroom report value so that the power of the cross link interference is less than or equal to the downlink sensitivity limit, the power headroom report value being applicable to a mixed slot where simultaneous transmissions in downlink and uplink are scheduled in non-overlapping sub-bands of the same carrier; and determining whether to report the power headroom report value, based on information received from a network node; wherein the power headroom report value is configured to be used to determine whether to reduce an uplink transmit power at the mixed slot.

Example 55. An apparatus includes means for determining whether to report a power headroom report value to a network node, the power headroom report value being applicable to a mixed slot where simultaneous transmissions in downlink and uplink are scheduled in non-overlapping sub-bands of the same carrier; wherein the power headroom report value is based on a difference between an uplink transmit power given an expected cross link interference for a user equipment, and an uplink transmit power at the mixed slot; and means for determining whether to reduce the uplink transmit power at the mixed slot, based on information received from the network node.

Example 56. An apparatus includes means for determining whether a mixed slot is expected to be used, the mixed slot being where simultaneous transmissions in downlink and uplink are scheduled in non-overlapping sub-bands of the same carrier; and means for transmitting information to at least one user equipment, the information configured to be used with the at least one user equipment to determine whether to report a power headroom report value, the power headroom report value being applicable to the mixed slot; wherein the power headroom report value is based on a difference between an uplink transmit power given an expected cross link interference for the at least one user equipment, and an uplink transmit power at the mixed slot; wherein the information is configured to be used with the at least one user equipment to determine whether to reduce the uplink transmit power at the mixed slot.

Example 57. An apparatus includes means for determining a downlink sensitivity limit that indicates an upper bound of a cross link interference level a user equipment has while the user equipment receives an acceptable signal to interference noise ratio; means for determining a power of the cross link interference; means for determining a power headroom report value so that the power of the cross link interference is less than or equal to the downlink sensitivity limit, the power headroom report value being applicable to a mixed slot where simultaneous transmissions in downlink and uplink are scheduled in non-overlapping sub-bands of the same carrier; and means for determining whether to report the power headroom report value, based on information received from a network node; wherein the power headroom report value is configured to be used to determine whether to reduce an uplink transmit power at the mixed slot.

Example 58. A non-transitory program storage device readable by a machine, tangibly embodying a program of instructions executable with the machine for performing operations, the operations including determining whether to report a power headroom report value to a network node, the power headroom report value being applicable to a mixed slot where simultaneous transmissions in downlink and uplink are scheduled in non-overlapping sub-bands of the same carrier; wherein the power headroom report value is based on a difference between an uplink transmit power given an expected cross link interference for a user equipment, and an uplink transmit power at the mixed slot; and determining whether to reduce the uplink transmit power at the mixed slot, based on information received from the network node.

Example 59. A non-transitory program storage device readable by a machine, tangibly embodying a program of instructions executable with the machine for performing operations, the operations including determining whether a mixed slot is expected to be used, the mixed slot being where simultaneous transmissions in downlink and uplink are scheduled in non-overlapping sub-bands of the same carrier; and transmitting information to at least one user equipment, the information configured to be used with the at least one user equipment to determine whether to report a power headroom report value, the power headroom report value being applicable to the mixed slot; wherein the power headroom report value is based on a difference between an uplink transmit power given an expected cross link interference for the at least one user equipment, and an uplink transmit power at the mixed slot; wherein the information is configured to be used with the at least one user equipment to determine whether to reduce the uplink transmit power at the mixed slot.

Example 60. A non-transitory program storage device readable by a machine, tangibly embodying a program of instructions executable with the machine for performing operations, the operations including determining a downlink sensitivity limit that indicates an upper bound of a cross link interference level a user equipment has while the user equipment receives an acceptable signal to interference noise ratio; determining a power of the cross link interference; determining a power headroom report value so that the power of the cross link interference is less than or equal to the downlink sensitivity limit, the power headroom report value being applicable to a mixed slot where simultaneous transmissions in downlink and uplink are scheduled in non-overlapping sub-bands of the same carrier; and determining whether to report the power headroom report value, based on information received from a network node; wherein the power headroom report value is configured to be used to determine whether to reduce an uplink transmit power at the mixed slot.

References to a ‘computer’, ‘processor’, etc. should be understood to encompass not only computers having different architectures such as single/multi-processor architectures and sequential or parallel architectures but also specialized circuits such as field-programmable gate arrays (FPGAs), application specific circuits (ASICs), signal processing devices and other processing circuitry. References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

The memory(ies) as described herein may be implemented using any suitable data storage technology, such as semiconductor based memory devices, flash memory, magnetic memory devices and systems, optical memory devices and systems, non-transitory memory, transitory memory, fixed memory and removable memory. The memory(ies) may comprise a database for storing data.

As used herein, the term ‘circuitry’ may refer to the following: (a) hardware circuit implementations, such as implementations in analog and/or digital circuitry, and (b) combinations of circuits and software (and/or firmware), such as (as applicable): (i) a combination of processor(s) or (ii) portions of processor(s)/software including digital signal processor(s), software, and memory(ies) that work together to cause an apparatus to perform various functions, and (c) circuits, such as a microprocessor(s) or a portion of a microprocessor(s), that require software or firmware for operation, even if the software or firmware is not physically present. As a further example, as used herein, the term ‘circuitry’ would also cover an implementation of merely a processor (or multiple processors) or a portion of a processor and its (or their) accompanying software and/or firmware. The term ‘circuitry’ would also cover, for example and if applicable to the particular element, a baseband integrated circuit or applications processor integrated circuit for a mobile phone or a similar integrated circuit in a server, a cellular network device, or another network device.

In the figures, arrows between individual blocks represent operational couplings there-between as well as the direction of data flows on those couplings.

It should be understood that the foregoing description is only illustrative. Various alternatives and modifications may be devised by those skilled in the art. For example, features recited in the various dependent claims could be combined with each other in any suitable combination(s). In addition, features from different example embodiments described above could be selectively combined into a new example embodiment. Accordingly, this description is intended to embrace all such alternatives, modifications and variances which fall within the scope of the appended claims.

The following acronyms and abbreviations that may be found in the specification and/or the drawing figures are defined as follows (the abbreviations and acronyms may be appended with each other or with other characters using e.g. a dash or hyphen):
3GPP third generation partnership project
4G fourth generation
5G fifth generation
5GC 5G core network
ACLR adjacent channel leakage ratio
AMF access and mobility management function
ASIC application-specific integrated circuit
BW bandwidth
BWP bandwidth part
CLI cross link interference
CMR channel measurement resource
CP-OFDM cyclic-prefix orthogonal frequency division multiplexing
CPU central processing unit
CSI channel state/status information
CU central unit or centralized unit
DCI downlink control information
DL downlink
DSP digital signal processor
DU distributed unit
eNB evolved Node B (e.g., an LTE base station)
EN-DC E-UTRAN new radio-dual connectivity
en-gNB node providing NR user plane and control plane protocol terminations towards the UE, and acting as a secondary node in EN-DC
E-UTRA evolved universal terrestrial radio access, i.e., the LTE radio access technology
E-UTRAN E-UTRA network
EVM error vector magnitude
F1 interface between the CU and the DU
FDM frequency division multiplexing
FIR finite impulse response
f-OFDM filtered orthogonal frequency-division multiplexing
FPGA field-programmable gate array
FR frequency range
GB guard band
gNB base station for 5G/NR, i.e., a node providing NR user plane and control plane protocol terminations towards the UE, and connected via the NG interface to the 5GC
IAB integrated access and backhaul
Id identifier
I/F interface
IM interference measurement
IMR interference measurement resource
I/O input/output
L3 layer 3
LMF location management function
LTE long term evolution (4G)
MAC medium access control
MAC CE MAC control element
max or MAX maximum
MCS modulation and coding scheme
MME mobility management entity
mpe or MPE maximum permitted exposure
MPR maximum power reduction
MRO mobility robustness optimization
NCE network control element
Nf length of the FIR filter coefficients
ng or NG new generation
ng-eNB new generation eNB
NG-RAN new generation radio access network
NR new radio (5G)
NW network
N/W network
Nws window slope length
OFDM orthogonal frequency division multiplexing
OOB out-of-band
out output
PA power amplifier
PDA personal digital assistant
PDCP packet data convergence protocol
PH power headroom
PHY physical layer
PHR power headroom report
P-MPR maximum allowed UE output power reduction
P-MPRc maximum allowed UE output power reduction for serving cell c
PRB physical resource block
PSCell primary secondary cell
PSD power spectral density
PUCCH physical uplink control channel
QPSK quadrature phase shift keying
RAM random access memory
RAN radio access network
RAN1 or RAN4 RAN meeting
Rel-release
RF radio frequency
RIC RAN intelligent controller
RLC radio link control
ROM read-only memory
RP RAN meeting
RRC radio resource control (protocol)
RRH remote radio head
RSRP reference signal received power
RSSI received signal strength indicator
RU radio unit
Rx or RX receiver or reception
SCell secondary cell
SC-FDMA single-carrier frequency-division multiple access
SDAP service data adaption protocol
SGW serving gateway
SINR signal to interference noise ratio
SLA side-lobe-attenuation
SMF session management function
SNR signal to noise ratio
SON self-organizing/optimizing network
SRS sounding reference signal
T threshold
TDD time-division duplex
TDM time division multiplexing
TO tone offset
TR technical report
TRP transmission and/or reception point
TS technical specification
Tx or TX transmitter or transmission
UAV unmanned aerial vehicle
UE user equipment (e.g., a wireless, typically mobile device)
UFMC universal filtered multi-carrier
UL uplink
UPF user plane function
WG working group
WOLA weighted overlap and add
X2 network interface between RAN nodes and between RAN and the core network
Xn network interface between NG-RAN nodes

The invention claimed is:

1-60. (canceled)

61. An apparatus comprising:
at least one processor; and
at least one memory, the at least one memory storing instructions, that when executed by the at least one processor, cause the apparatus at least to:
determine whether to report a power headroom report value to a network node, the power headroom report value being applicable to a mixed slot where simultaneous transmissions in downlink and uplink are scheduled in non-overlapping sub-bands of the same carrier;
wherein the power headroom report value is based on a difference between an uplink transmit power given an expected cross link interference for a user equipment, and an uplink transmit power at the mixed slot; and
determine whether to reduce the uplink transmit power at the mixed slot, based on information received from the network node.

62. The apparatus of claim 61, wherein the instructions, when executed by the at least one processor, further cause the apparatus at least to:
transmit, to the network node, the power headroom value applicable to the mixed slot.

63. The apparatus of claim 61, wherein the instructions, when executed by the at least one processor, further cause the apparatus at least to:
report the power headroom report value as a change from another power headroom report value, the another power headroom report value being applicable to at least one uplink slot.

64. The apparatus of claim 61, wherein the instructions, when executed by the at least one processor, further cause the apparatus at least to:
determine the power headroom report value with an assumption that a reception reference signal received power of the apparatus is substantially similar to a reception reference signal received power of the user equipment.

65. The apparatus of claim 61, wherein the instructions, when executed by the at least one processor, further cause the apparatus at least to:
determine a downlink sensitivity limit that indicates an upper bound of a cross link interference level the user equipment has while the user equipment receives an acceptable signal to interference noise ratio;
determine a power of the cross link interference; and
determine the power headroom report value so that the power of the cross link interference is less than or equal to the downlink sensitivity limit.

66. The apparatus of claim 65, wherein the instructions, when executed by the at least one processor, further cause the apparatus at least to:
determine the downlink sensitivity limit as at least partially a downlink reception reference signal received power added to at least partially an offset;
determine the power of the cross link interference as at least partially the uplink transmit power given the expected cross link interference minus at least partially a power attenuation to an adjacent channel minus at least partially a propagation loss between the apparatus and the user equipment.

67. The apparatus of claim 66, wherein the downlink reception reference signal received power is of the apparatus or the user equipment.

68. The apparatus of claim 66, wherein the instructions, when executed by the at least one processor, further cause the apparatus at least to:
receive a configuration of the offset from the network node.

69. The apparatus of claim 61, wherein the instructions, when executed by the at least one processor, further cause the apparatus at least to:
determine the uplink transmit power given the expected cross link interference as at least partially a downlink reception reference signal received power plus at least partially an offset plus at least partially a power attenuation to an adjacent channel plus at least partially a propagation loss between the apparatus and the user equipment; and
determine the power headroom report value as at least partially the determined uplink transmit power given the expected cross link interference minus at least partially the uplink transmit power at the mixed slot.

70. An apparatus comprising:
at least one processor; and
at least one memory, the at least one memory storing instructions, that when executed by the at least one processor, cause the apparatus at least to:
determine whether a mixed slot is expected to be used, the mixed slot being where simultaneous transmissions in downlink and uplink are scheduled in non-overlapping sub-bands of the same carrier; and
transmit information to at least one user equipment, the information configured to be used with the at least one user equipment to determine whether to report a power headroom report value, the power headroom report value being applicable to the mixed slot;
wherein the power headroom report value is based on a difference between an uplink transmit power given an expected cross link interference for the at least one user equipment, and an uplink transmit power at the mixed slot;
wherein the information is configured to be used with the at least one user equipment to determine whether to reduce the uplink transmit power at the mixed slot.

71. The apparatus of claim 70, wherein the at least one memory and the computer program code are configured to, with the at least one processor, cause the apparatus at least to:
receive, from the at least one user equipment, the power headroom report value applicable to the mixed slot.

72. The apparatus of claim 70, wherein the instructions, when executed by the at least one processor, further cause the apparatus at least to:
receive the power headroom report value as a change from another power headroom report value.

73. The apparatus of claim 70, wherein the instructions, when executed by the at least one processor, further cause the apparatus at least to:
transmit an offset to the at least one user equipment, the offset configured to be used with the at least one user equipment to determine a downlink sensitivity limit that indicates an upper bound of a cross link interference level the user equipment has while the user equipment receives an acceptable signal to interference noise ratio, the downlink sensitivity limited determined as at least partially a downlink reception reference signal received power added to at least partially the offset; and
transmit a delta value to the at least one user equipment, the delta value configured to be used with the at least one user equipment to determine a power of the cross link interference as at least partially the uplink transmit power given the expected cross link interference minus at least partially a power attenuation to an adjacent channel minus at least partially the delta value;
wherein the delta value represents a propagation loss between a first user equipment of the at least one user equipment and a second user equipment of the at least one user equipment.

74. An apparatus comprising:
at least one processor; and
at least one memory, the at least one memory storing instructions, that when executed by the at least one processor, cause the apparatus at least to:
determine a downlink sensitivity limit that indicates an upper bound of a cross link interference level a user equipment has while the user equipment receives an acceptable signal to interference noise ratio;
determine a power of the cross link interference;
determine a power headroom report value so that the power of the cross link interference is less than or equal to the downlink sensitivity limit, the power headroom report value being applicable to a mixed slot where simultaneous transmissions in downlink and uplink are scheduled in non-overlapping sub-bands of the same carrier; and
determine whether to report the power headroom report value, based on information received from a network node;
wherein the power headroom report value is configured to be used to determine whether to reduce an uplink transmit power at the mixed slot.

75. The apparatus of claim 74, wherein the instructions, when executed by the at least one processor, further cause the apparatus at least to:
receive an offset from the network node;
determine the downlink sensitivity limit as at least partially a downlink reception reference signal received power added to at least partially the offset;
receive a delta value from the network node, the delta value representing a propagation loss between the apparatus and the user equipment; and
determine the power of the cross link interference as at least partially the uplink transmit power given an expected cross link interference minus at least partially a power attenuation to an adjacent channel minus at least partially the delta value.

76. The apparatus of claim 75, wherein the downlink reception reference signal received power is of the apparatus or the user equipment.

77. The apparatus of 74, wherein the instructions, when executed by the at least one processor, further cause the apparatus at least to:
determine the uplink transmit power given an expected cross link interference as at least partially a downlink reception reference signal received power plus at least partially an offset plus at least partially a power attenuation to an adjacent channel plus at least partially a propagation loss between the apparatus and the user equipment; and
determine the power headroom report value as at least partially the determined uplink transmit power given the expected cross link interference minus at least partially an uplink transmit power at the mixed slot.

78. The apparatus of claim 74, wherein the instructions, when executed by the at least one processor, further cause the apparatus at least to:
report to the network node a capability to reduce an in-band emission level;
receive an offset used to determine the downlink sensitivity limit that indicates the upper bound of the acceptable cross link interference level of the user equipment, the offset based on the report to the network node of the capability to reduce the in-band emission level.

79. The apparatus of claim 78, wherein the instructions, when executed by the at least one processor, further cause the apparatus at least to:
receive an indication to not report the power headroom report value, based on the reported capability to reduce the in-band emission level, the information received from the network node comprising the indication.

80. The apparatus of claim 74, wherein the instructions, when executed by the at least one processor, further cause the apparatus at least to:
receive, from the network node, a configuration comprising a cross link interference reporting threshold, the information received from the network node comprising the indication;
determine a downlink reference signal received power of the apparatus; and
report the power headroom report value to the network node, in response to the downlink reference signal received power being lower than the cross link interference reporting threshold.
